(19) United States
(12) Patent Application Publication
(10) Pub. No.: US 2008/0272750 A1
(43) Pub. Date: Nov. 6, 2008

(54) Device

(75) Inventor: Timo Aitto-Oja, Oulu (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: NOKIA CORPORATION

(21) Appl. No.: 11/892,284

(22) Filed: Aug. 21, 2007

(30) Foreign Application Priority Data
May 4, 2007 (GB) 0708733.1

(51) Int. Cl. G05F 1/00

(52) U.S. Cl. 323/266

(57) ABSTRACT

A device includes an output and a linear regulator coupled to the output. The device also includes a switching regulator coupled to the output and means for controlling said switching regulator in dependence on power loss in said linear regulator.

### FIELD OF THE INVENTION

The present invention relates to a device and method and, in particular but not exclusively, to a device for use in a base station in a wireless telecommunications network.

### BACKGROUND

Electrical power amplifiers normally have peak efficiency when operated at a maximum output power. The maximum output power of a power amplifier is related to the supply voltage to the amplifier. When power amplifiers are used as signal amplifiers in a radio frequency (RF) system, the input signal to be amplified may have a large bandwidth resulting in a large range of required output powers.

In order to maintain efficiency of operation of the power amplifier an envelope tracking system can be employed. In an envelope tracking system, the supply voltage to the power amplifier is continuously adjusted to match the required instantaneous power output of the amplifier. Thus the instantaneous maximum power output of the amplifier is controlled by the supply voltage to match the required power output for the amplified signal. Operating the power amplifier at or near the maximum power output of the amplifier ensures that the amplifier operates efficiently.

Referring to FIG. 2, a known supply voltage modulator 1 for providing a supply voltage to signal amplifier 6 is illustrated. The modulator 1 comprises linear regulator 2, switching regulator 4, current sense resistor 5, and comparator circuit 8.

A linear regulator control voltage signal 3 is coupled to an input of the linear regulator 2. An output of linear regulator 2 is coupled to a node of current sense resistor 5 and also to a non-inverting input of comparator 8. A further node of current sense resistor 5 is coupled to the supply voltage modulator output 9 and also to an inverting input of comparator 8. An output of comparator 8 is coupled to a non-inverting input of switching regulator 4 to provide switching regulator control voltage 7. An inverting input of switching regulator 4 is coupled to ground. The output of switching regulator 4 is coupled to the output 9 of the modulator 1.

In operation, the supply voltage modulator 1 is controlled by the linear regulator control voltage 3 to provide an adjustable voltage output 9 to the signal amplifier 6. Linear regulator 2 is directly controlled by the linear regulator control voltage 3 to output the required voltage. Control of switching regulator 4 is achieved by measuring the output current of linear regulator 2. This current is measured by determining a voltage drop across current sense resistor 5 using comparator 8. If linear regulator 2 is sourcing current then a positive voltage drop will be measured across current sense resistor 5 leading to a positive switching regulator control voltage 7 being generated by comparator 8. This positive switching regulator control voltage 7 will cause the switching regulator 4 to increase its voltage output. Alternatively, if the linear regulator 2 is sinking current then a negative voltage drop will be determined leading to a negative switching regulator control voltage 7 and a reduction in the switching regulator output voltage.

By combining the linear regulator 2 and the switching regulator 4 in this way, the output power of the supply voltage modulator 1 is mainly supplied by the switching regulator 4. This is desirable as switching regulators are known to have higher efficiency than linear regulators, and therefore the efficiency of the device overall is improved. However, switching regulators have low bandwidth and produce a noisy output signal including an output ripple current. The linear regulator 2 exhibits high bandwidth and is therefore able to respond more quickly to changes in the required output current, and may also compensate for the noisy output of the switching regulator 4.

For the modulator 1 of FIG. 2, the measurement of current flowing through the current sensing resistor 5 is complicated due to the large common-mode signal present across the resistor 5, and the presence of the current measurement components on the output of the linear regulator can lead to voltage distortions. Furthermore, no account is taken of the variation in operating efficiency of the linear regulator 2 for different output voltages.

It is an aim of some embodiments of the present invention to address, or at least mitigate, some of these problems.

### SUMMARY

According to an aspect of the present invention, there is provided a device comprising an output, a linear regulator coupled to the output, a switching regulator coupled to the output, and means for controlling said switching regulator in dependence on power loss in said linear regulator.

Preferably said linear regulator comprises current sourcing means, and said means for controlling is arranged to control said switching regulator in dependence on the power loss in said current sourcing means. The linear regulator may comprise current sinking means, and said means for controlling is arranged to control said switching regulator in dependence on the power loss in said current sinking means.

The means for controlling may be further arranged to control said switching regulator in dependence on a difference between the power loss in said current sourcing means and the power loss in said current sinking means.

The means for controlling may further comprise power sensing means for generating a signal representative of power loss. The power sensing means may comprise current sensing means for determining an electrical current in the linear regulator, voltage sensing means for determining a voltage drop in the linear regulator, and generating means for using said determined current and said determined voltage to generate a control signal representative of said power loss. The generating means may be arranged to multiply said determined current by said determined voltage to generate a control signal representative of said power loss.

The current sensing means may comprise a current sense resistor, and an amplifier arranged to determine a voltage drop across said resistor.

The power sensing means may further comprise first power sensing means for generating a signal representative of power loss in said current sourcing means, and second power sensing means for generating a signal representative of power loss in said current sinking means.

Preferably, said current sourcing means comprises at least one current sourcing transistor, and said current sinking means comprises at least one current sinking transistor.

According to a further aspect of the invention, there is provided a method of controlling a switching regulator, said method comprising determining power loss in a linear regulator, and controlling said switching regulator in dependence on said determined power loss.

Determining the power loss in the linear regulator may further comprise determining a power loss in current sourcing means of the linear regulator. Determining the power loss in the linear regulator may further comprise determining a power loss in current sinking means of the linear regulator.

Preferably, controlling said switching regulator further comprises controlling said switching regulator in dependence on a difference between said determined power loss in said current sourcing means and said determined power loss in said current sinking means.

Determining the power loss in the linear regulator may further comprise determining an electrical current in the linear regulator, determining a voltage drop in the linear regulator, and using the determined current and the determined voltage drop to generate a control signal representative of power loss.

Preferably, using the determined current and the determined voltage drop further comprises multiplying said determined current by said determined voltage drop to generate said control signal.

According to a further aspect of the invention, there is provided a device comprising an output, a linear regulator coupled to the output, a switching regulator coupled to the output, and control circuitry configured to control said switching regulator in dependence on power loss in said linear regulator.

According to a further aspect of the invention, there is provided a transmitter comprising, a signal amplifier, and a supply voltage modulator configured to modulate a supply voltage for the signal amplifier, the supply voltage modulator comprising, an output, a linear regulator coupled to the output, a switching regulator coupled to the output, and control circuitry configured to control said switching regulator in dependence on power loss in said linear regulator.

Preferably, the transmitter may be a base station, or a user equipment.

### BRIEF DESCRIPTION OF THE DRAWINGS

The present invention is now described by way of example only with reference to the accompanying Figures, in which:

FIG. 1 illustrates a block diagram of a wireless telecommunications system including an envelope tracking system;

FIG. 2 illustrates a block diagram of the supply voltage modulator of FIG. 1;

FIG. 3 illustrates a block diagram of a supply voltage modulator embodying the concept of the present invention;

FIG. 4 illustrates the current versus time characteristics for the supply voltage modulator of FIG. 2.

FIG. 5 illustrates the current versus time characteristics for the supply voltage modulator of FIG. 3.

### DESCRIPTION OF PREFERRED EMBODIMENTS

Embodiments of the present invention are described herein by way of particular examples and specifically with reference to preferred embodiments. It will be understood by one skilled in the art that the invention is not limited to the details of the specific embodiments given herein.

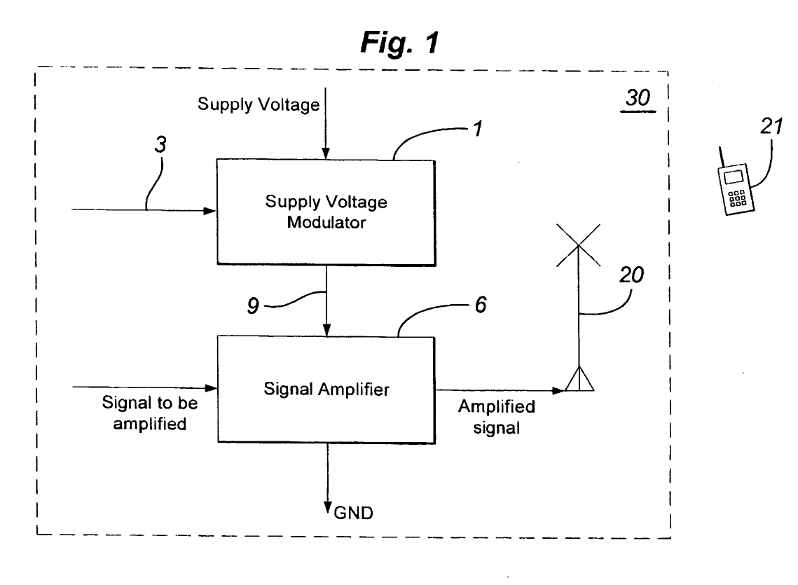

An example transmitter 30, including an envelope tracking system, that may be used in a wireless communications system is shown in FIG. 1. The system comprises two parts: a signal amplifier 6; and a supply voltage modulator 1. The signal amplifier part comprises the power amplifier and receives as an input the signal which is to be amplified, and supplies the amplified signal as its output which is coupled to an antenna 20. The supply voltage modulator 1 is controlled using the signal envelope of the signal to be amplified. The envelope level is amplified to provide a suitable supply voltage for use by the signal amplifier.

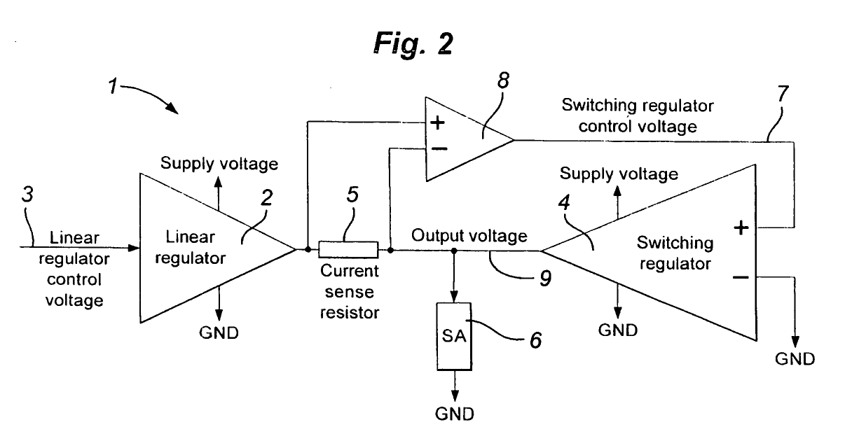

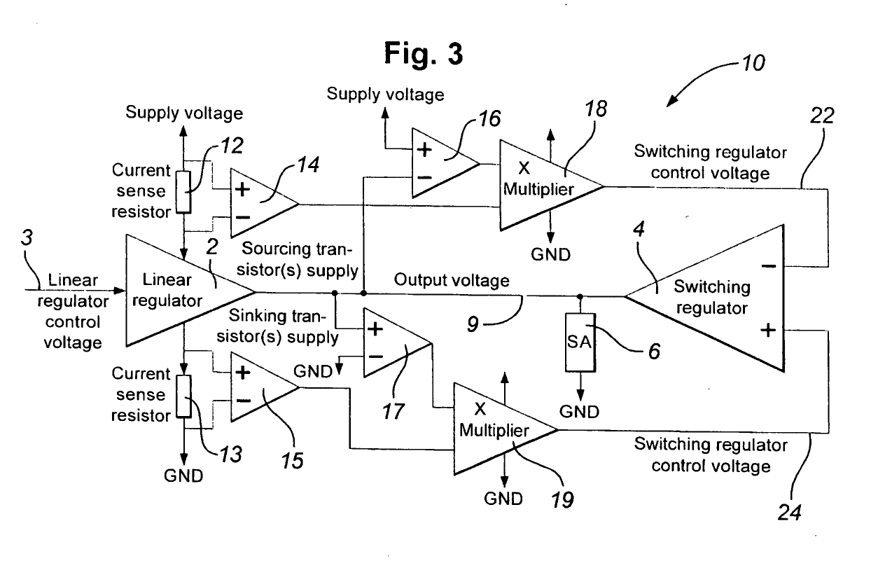

Referring to FIG. 3 there is illustrated one embodiment of a supply voltage modulator 10, suitable for use in the transmitter of FIG. 1, for supplying a modulated supply voltage to signal amplifier 6, in accordance with an embodiment of the present invention. The same numbers are used for like components in FIG. 3 as for FIG. 2. The modulator comprises linear regulator 2, switching regulator 4, first and second current sense resistors 12, 13, first and second amplifier circuits 14, 15, third and fourth amplifier circuits 16, 17, and first and second multipliers 18, 19.

In the described embodiment, linear regulator control voltage 3 is coupled to an input of the linear regulator 2, and the output of linear regulator 2 is coupled to the output 9 of the supply voltage modulator. First current sensing resistor 12 is coupled in series between the supply voltage and a supply voltage input of linear regulator 2. The supply voltage is coupled to a non-inverting input of first amplifier 14, and to a non-inverting input of third amplifier 16. The supply voltage input of regulator 2 is coupled to an inverting input of first amplifier 14. An output of first amplifier 14 is coupled to an input of first multiplier 18. An inverting input of third amplifier 16 is coupled to the supply voltage modulator output 9, and the output of the third amplifier 16 is coupled to another input of first multiplier 18. The output of first multiplier 18 is coupled to a non-inverting input of switching regulator 4 to provide a first switching regulator control voltage 22. The output of switching regulator 4 is coupled to the supply voltage modulator output 9. The arrangement of second current sensing resistor 13, second and forth amplifiers 15, 17, and second multiplier 19 mirrors the arrangement of the first current sense resistor 12, first and third amplifiers 14, 16, and first multiplier 18 to provide a second switching regulator control voltage 24, that is coupled to an inverting input of the switching regulator.

In one embodiment the linear regulator comprises a transistor for sourcing current from the supply voltage, and a further transistor for sinking current to ground. The linear regulator is able to maintain a steady output voltage by controlling the state of each transistor to act as a voltage divider.

In the disclosed embodiment, power losses in the current sourcing transistor of the linear regulator 2 are determined using first current sense resistor 12, amplifier circuits 14, and 16, and first multiplier 18. As power is current times voltage, power loss in the current sourcing transistor can be determined by measuring the voltage supply current passing through the current sourcing transistor and multiplying this measured value with the voltage drop across the current sourcing transistor, that is the supply voltage minus the output voltage 9.

The voltage supply current passing through the current sourcing transistor is determined by monitoring the drop in voltage across first current sense resistor 12 using first amplifier 14. The inputs of first amplifier 14 are coupled to the supply voltage and the supply voltage input of linear regulator 2, and the output of the amplifier represents the difference in voltage of the inputs. Therefore, the output of amplifier 14 is representative of voltage dropped across the first current sense resistor, and hence the current through the resistor.

The voltage drop across the current sourcing transistor of the linear regulator 2 is determined using third amplifier 16. The inputs of the amplifier 16 are coupled to the supply voltage and the output voltage, and therefore the output of the amplifier 16 is representative of the total voltage dropped across the first current sense resistor 12 and the current sourcing transistor of the linear regulator 2.

The output of first amplifier 14 and of third amplifier 16 is coupled to multiplier 18 which multiplies the input values together to produce an output 22. This output 22 is therefore representative of the current through the sourcing transistor, as provided by the output of first amplifier 14, multiplied by the voltage drop between the supply voltage and the output voltage, as provided by the output of third amplifier 16. As current through a component multiplied by the voltage drop across that component is equal to the power dissipated in that component, the output 22 of first multiplier 18 is representative of the power dissipated in the current sourcing transistor of the linear regulator 2.

Similarly, the current in the current sinking transistor may be determined using second current sense resistor 13, coupled between ground and the linear regulator 2, and second amplifier 15 arranged to determine the voltage drop across second current sense resistor 13 and thereby output a value representative of the current through the current sinking transistor of linear regulator 2. The voltage dropped across the current sinking transistor may be determined using fourth amplifier 17 with inputs coupled to the output voltage and to ground. The power losses in the current sinking transistor may then be determined by multiplying the outputs of second amplifier 15 and fourth amplifier 17 together in second multiplier 19 to produce the second switching regulator control voltage 24.

The output signals 22 and 24 from first multiplier 18 and second multiplier 19 are then used to control the output of the switching regulator 4. First multiplier 18 is coupled to a non-inverting input of switching regulator 4, and second multiplier 19 is coupled to an inverting input of switching regulator 4. Therefore, if the power losses in the sourcing transistor and the sinking transistor are equal, the outputs of the first and second multipliers will be the same leading to no change in the output of the switching regulator 4.

However, if power losses are greater in the sourcing transistor then the output of the first multiplier 18 will be greater than the output of the second multiplier 19, which will control the switching regulator 4 to increase its output voltage. This will lead to less current being sourced through the linear regulator 2 and therefore reduce the power losses in the sourcing transistor of the linear regulator 2.

If the power losses are greater in the sinking transistor of the linear regulator, then the output of the second multiplier 19 will be greater than the output of the first multiplier 18, which will control the switching regulator 4 to decrease its output voltage. This will lead to less current being sunk through the linear regulator 2 and therefore reduce power losses in the sinking transistor of the linear regulator 2.

Thus, in the described embodiment the control signals 22 and 24 are representative of the power losses in the current sourcing and current sinking transistors, respectively, of the linear regulator 2. These control signals 22, 24 act to control the output of the switching voltage regulator such that the power losses on each set of transistors are equalised.

The efficiency of linear voltage regulators is related to the output voltage and current of the linear regulator. When sourcing current, linear regulators are most efficient when the output voltage approaches the supply voltage. This is because when the output voltage is near the supply voltage the current sourcing transistor has a low resistance, as only a small voltage must be dropped across it, and therefore low power losses in supplying the required current. However, when the output voltage is near the supply voltage, linear regulators are less efficient at sinking current.

In other words, the power losses in the linear amplifier are lower for a net current being sourced from the linear regulator when the output voltage is a large proportion of the supply voltage.

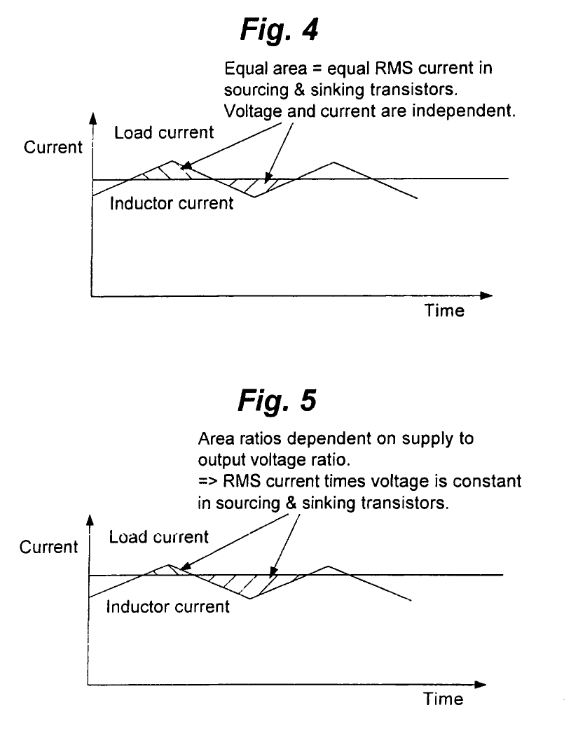

For each switching cycle of the switching regulator 4, the linear regulator 2 will be required to source and sink small amount of current to smooth the ripple current output of the switching regulator. In the case of the supply voltage modulator 1 of FIG. 2, the switching regulator 4 is controlled to minimise the average output current of linear regulator 2. Therefore there is negligible DC current output by the linear regulator 2, and the current sourced from the linear regulator to smooth troughs in the current output of the switching regulator 4 is equal to the current sunk through the linear regulator 2 to smooth peaks in the switching regulator current output. This is shown in FIG. 4.

For supply voltage modulator 1, the current sourced from the linear regulator is equal to the current sunk by the linear regulator over a single cycle of the switching regulator. Therefore the power dissipation in the linear regulator 2 to smooth the ripple current is independent of the ratio between the output voltage 9 and the supply voltage. Assuming a continuous inductor current supplied by the switching regulator 4, the power dissipation due to ripple current effects in the supply voltage modulator 1 is given by the equation:

$${P}_{dissipation} [ W ] = \frac{{V}_{O}^{2} ( {V}_{S} - {V}_{O} )}{8 {V}_{S} {LF}_{s}} + \frac{{{V}_{O} ( {V}_{S} - {V}_{O} )}^{2}}{8 {V}_{S} {LF}_{s}} \qquad ( 1 )$$

where:

V_{S} is the supply voltage,

V_{O} is the output voltage 9 of the supply voltage modulator,

Fₛ is the switching frequency of the switching regulator, and

L is the inductance of the inductor used in the switching regulator.

According to an exemplary embodiment of the present invention, the linear regulator output current is not measured at all, and therefore there is no need for a current sense resistor coupled to the output of the linear regulator. Control signals for the switching regulator are instead determined by measuring power losses in the linear regulator.

When the linear regulator sources or sinks an output current a current imbalance exists in the sourcing and sinking transistors. That is, when the linear regulator output acts as a current source, more current flows through the sourcing transistor than through the sinking transistor, and when the output acts as a current sink, more current flows through the sinking transistor than the sourcing transistor. As current through a component is related to the power dissipated in that component, when the linear regulator acts as a current source or sink the power losses on the sourcing and sinking transistors becomes unequal.

The efficiency of a supply voltage modulator comprising a linear voltage regulator and a switching voltage regulator arranged in parallel may be improved in embodiments of the present invention by taking into account the operating regime of the linear voltage regulator. If the desired output voltage is near the supply voltage, the linear regulator is more efficient when sourcing current than for a lower output voltage, and the modulator will be more efficient when the switching regulator is controlled to output an average voltage slightly less than the required modulator output. The linear regulator will then source slightly more current than it sinks when smoothing the output of the switching regulator.

However, if the desired output voltage is near ground, the linear regulator is less efficient at sourcing current and therefore the modulator will be more efficient when the switching regulator is controlled to output an average voltage slightly greater than the desired modulator output. The linear regulator will then sink slightly more current than it sources when smoothing the output of the switching regulator.

Maximum efficiency of the linear regulator can be achieved when the switching regulator is controlled such that the RMS current multiplied by the voltage drop associated with the current sourcing transistor and the current sinking transistor in the linear regulator is equal for both sourcing and sinking transistors. In other words, as power equals current multiplied by voltage, maximum efficiency of the linear regulator is achieved when the power losses in the sourcing transistor are equal to the power losses in the sinking transistor. The power losses in the sourcing transistor and the sinking transistor can be measured and used to provide control of the switching regulator. Control of the switching regulator based on the difference between measured power losses acts to keep losses equal on both sets of transistors, thereby maximising efficiency.

For a linear regulator operating in this manner, the amount of current sourced from the linear regulator in one switching cycle is no longer equal to the amount of current sunk through the linear regulator over that cycle, as can be seen in FIG. 5 which shows an equivalent situation to FIG. 4 for a supply modulator implementing the modified control method. There is, therefore, a net DC current provided by the linear regulator. Furthermore, power dissipation in the linear regulator due to the current required to smooth the ripple current is no longer independent of the ratio between the output voltage 9 and the supply voltage. Assuming continuous inductor current, the power dissipation due to ripple current effects in the supply voltage modulator embodying the principles of the present invention is given by the equation:

$${P}_{dissipation} [ W ] = \frac{{{V}_{O} ( {V}_{S} - {V}_{O} )}^{2}}{{V}_{S} {{LF}_{s} ( 1 + \sqrt{\frac{{V}_{S} - {V}_{O}}{{V}_{O}}} )}^{2}} \qquad ( 2 )$$

where:

V_{S}, V_{O}, f_{sw} and L have the same meanings as above.

When the switching regulator is controlled, as described above, in dependence on the output voltage 9 in relation to the supply voltage, overall efficiency of the modulator can be improved over the modulator 1 of FIG. 2 for all operating conditions except when the desired output voltage is exactly half the supply voltage. As can be seen from equations 1 and 2, in the case that the desired output voltage 9 is exactly half the supply voltage the efficiency of both modulators would be identical.

Thus, control of the switching regulator to ensure the linear regulator operates in the most efficient way may be achieved by monitoring power losses on the sourcing and sinking transistors of the linear regulator. The switching regulator 4 may then be controlled responsive to a difference between the determined power losses in order to equalise the power losses on the current sourcing and current sinking transistors of the linear regulator.

Total efficiency of an envelope tracking system is a combination of the signal amplifier and supply voltage modulator efficiencies. Embodiments of the present invention may improve the control of switching regulators in supply voltage modulators to thereby improve the overall efficiency of the envelope tracking system. Furthermore, the switching regulator is controlled so that efficiency of operation of the supply voltage modulator may be optimal in any possible operating situation.

As well as improved operating efficiency, some embodiments of the present invention may have one or more of the following further advantages, including: monitoring of linear regulator supply currents simplifies over-current limiting of the modulator; matching power losses on sourcing and sinking transistors leads to increased reliability of the linear regulator; and removal of current measurement components from linear regulator output decreases output voltage distortion and allows the layout of the modulator to be optimised. Furthermore, in the modulator of FIG. 2, measurement of current flowing through the current sensing resistor 5 is complicated due to the large common-mode signal present across the resistor 5. In embodiments of the present invention the required current measurements can be taken so that no common-mode signal is present greatly simplifying the measurement of these currents.

Embodiments of the present invention are particularly suited for use in transmitters using Envelope Tracking or Envelope Elimination and Restoration power amplifiers. Such power amplifiers may be used in base stations 30 in mobile telecommunications networks such as in FIG. 1. In particular, medium to high power transmitters would especially benefit from the increased operating efficiency offered by the present invention. However, more generally the invention may apply to any arrangement where it is necessary to provide a voltage supply that may be adjusted in response to a control signal.

Embodiments of the present invention may also be suitable for use in transmitters for user equipment 21. User equipment 21 includes all equipment that is in possession of the end user, such as a computer, WLAN radio interface adapter etc. The user equipment may for example be a personal digital assistant (PDA), portable computer, fixed computer, mobile telephone or combinations thereof.

While the described embodiment uses analogue electronic components to measure the power losses on the sourcing and sinking transistors, other embodiments of the invention may be implemented using digital or analogical means for measuring the power losses, or a combination of both types of components may be used.

1. A device comprising:
an output;
a linear regulator coupled to the output;
a switching regulator coupled to the output; and
means for controlling said switching regulator in dependence on power loss in said linear regulator.

2. The device of claim 1, wherein said linear regulator comprises current sourcing means, and wherein said means for controlling is arranged to control said switching regulator in dependence on the power loss in said current sourcing means.

3. The device of claim 1, wherein said linear regulator comprises current sinking means, and wherein said means for controlling is arranged to control said switching regulator in dependence on the power loss in said current sinking means.

4. The device of claim 2, wherein said linear regulator further comprises current sinking means, and wherein said means for controlling is further arranged to control said switching regulator in dependence on a difference between the power loss in said current sourcing means and the power loss in said current sinking means.

5. The device of claim 1, wherein said means for controlling further comprises power sensing means for generating a signal representative of power loss.

6. The device of claim 5, wherein said power sensing means further comprises:
current sensing means for determining an electrical current in the linear regulator;
voltage sensing means for determining a voltage drop in the linear regulator; and
generating means for using said determined current and said determined voltage to generate a control signal representative of said power loss.

7. The device of claim 6, wherein said generating means is arranged to multiply said determined current by said determined voltage to generate a control signal representative of said power loss.

8. The device of claim 6, wherein the current sensing means comprises:
a current sense resistor; and
an amplifier arranged to determine a voltage drop across said resistor.

9. The device of claim 5, wherein said power sensing means further comprises:
first power sensing means for generating a signal representative of power loss in a current sourcing means; and
second power sensing means for generating a signal representative of power loss in a current sinking means.

10. The device of claim 2, wherein said current sourcing means comprises at least one current sourcing transistor.

11. The device of claim 3, wherein said current sinking means comprises at least one current sinking transistor.

12. A method of controlling a switching regulator, said method comprising:
determining power loss in a linear regulator; and
controlling said switching regulator in dependence on said determined power loss.

13. The method of claim 12, wherein determining the power loss in the linear regulator further comprises determining a power loss in a current sourcing means of the linear regulator.

14. The method of claim 12, wherein determining the power loss in the linear regulator further comprises determining a power loss in a current sinking means of the linear regulator.

15. The method of claim 13, wherein determining the power loss in the linear regulator further comprises determining a power loss in the current sinking means of the linear regulator, and wherein controlling said switching regulator further comprises controlling said switching regulator in dependence on a difference between said determined power loss in said current sourcing means and said determined power loss in said current sinking means.

16. The method of claim 12, wherein determining the power loss in the linear regulator further comprises:
determining an electrical current in the linear regulator;
determining a voltage drop in the linear regulator; and
using the determined current and the determined voltage drop to generate a control signal representative of power loss.

17. The method of claim 16, wherein using the determined current and the determined voltage drop further comprises multiplying said determined current by said determined voltage drop to generate said control signal.

18. A device comprising:
an output;
a linear regulator coupled to the output;
a switching regulator coupled to the output; and
control circuitry configured to control said switching regulator in dependence on power loss in said linear regulator.

19. A transmitter comprising:
a signal amplifier; and
a supply voltage modulator configured to modulate a supply voltage for the signal amplifier, the supply voltage modulator comprising
an output;
a linear regulator coupled to the output;
a switching regulator coupled to the output; and
control circuitry configured to control said switching regulator in dependence on power loss in said linear regulator.

20. The transmitter of claim 19, wherein said transmitter is a base station.

21. The transmitter of claim 19, wherein said transmitter is a user equipment.
